(19) United States
(12) Patent Application Publication
(10) Pub. No.: US 2024/0124628 A1
(43) Pub. Date: Apr. 18, 2024

(54) BICYCLIC HAFNIUM METALLOCENES HAVING NONIDENTICAL LIGANDS

(71) Applicant: Dow Global Technologies LLC, Midland, MI (US)

(72) Inventors: Angela I. Padilla-Acevedo, Lake Jackson, TX (US); Rhett A. Baillie, Pearland, TX (US); Roger L. Kuhlman, Lake Jackson, TX (US); Mahsa McDougal, Freeport, TX (US); Tamara L. Brennan, Pearland, TX (US); David M. Pearson, Lake Jackson, TX (US); Stephanie M. Whited, Charleston, WV (US)

(73) Assignee: Dow Global Technologies LLC, Midland, MI (US)

(21) Appl. No.: 18/276,173

(22) PCT Filed: Feb. 8, 2022
(86) PCT No.: PCT/US2022/015602

§ 371 Date: Aug. 7, 2023

Related U.S. Application Data
(60) Provisional application No. 63/147,490, filed on Feb. 9, 2021.

(51) Int. Cl. C08F 210/16; C07F 17/00

(52) U.S. Cl. CPC C08F 210/16; C07F 17/00

(57) ABSTRACT

Embodiments of the present disclosure are directed towards bicyclic hafnium metallocenes having non-identical ligands and compositions including the bicyclic hafnium metallocenes having non-identical ligands. The bicyclic hafnium metallocene having non-identical ligands is represented by formula (I): ABMX2, where: A is a bicyclic structure; and B is a cyclopentadienyl; M is hafnium; and X is a leaving group, wherein the bicyclic structure comprises a ((C₁-C₆)alkyl)n-substituted Cp ring and a non-aromatic cyclic structure fused with the ((C1-C6) alkyl)n-substituted Cp ring such that the bicyclic structure includes 7 to 9 ring carbon atoms and wherein subscript n is 1, 2, or 3.

### FIELD OF DISCLOSURE

Embodiments of the present disclosure are directed towards bicyclic hafnium metallocenes having nonidentical ligands and compositions including bicyclic hafnium metallocenes having nonidentical ligands.

### BACKGROUND

Metallocenes can be used in various applications, including as polymerization catalysts. Polymers may be utilized for a number of products including films, among others. Polymers can be formed by reacting one or more types of monomer in a polymerization reaction. There is continued focus in the industry on developing new and improved materials and/or processes that may be utilized to form polymers.

### SUMMARY

The present disclosure provides various embodiments, including:

A bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)n-substituted cyclopentadienyl ring and a non-aromatic cyclic structure fused with the ((C₁-C₆)alkyl)n-substituted cyclopentadienyl ring such that the bicyclic structure includes 7 to 9 ring carbon atoms and wherein subscript n is 1, 2, or 3. A bicyclic hafnium metallocene catalyst composition comprising: a bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)n-substituted cyclopentadienyl ring and a non-aromatic cyclic structure fused with the ((C₁-C₆)alkyl)n-substituted cyclopentadienyl ring such that the bicyclic structure includes 7 to 9 ring carbon atoms and wherein subscript n is 1, 2, or 3; and an activator.

A method of making a polymer, the method comprising: contacting the bicyclic hafnium metallocene catalyst composition comprising: a bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)n-substituted cyclopentadienyl ring and a non-aromatic cyclic structure fused with the ((C₁-C₆)alkyl)n-substituted cyclopentadienyl ring such that the bicyclic structure includes 7 to 9 ring carbon atoms and wherein subscript n is 1, 2, or 3; and an activator, with an olefin under polymerization conditions to make the polymer.

### BRIEF DESCRIPTION OF THE DRAWINGS

FIG. 1 shows molecular weight comonomer distribution index (MWCDI) in accordance a number of embodiments of the present disclosure.

### DETAILED DESCRIPTION

Bicyclic hafnium metallocenes having nonidentical ligands are discussed herein. Advantageously, these bicyclic hafnium metallocenes having nonidentical ligands can be utilized to make catalyst compositions, for instance. These catalyst compositions can be utilized to make polymers having an improved, i.e. greater, molecular weight comonomer distribution index (MWCDI) as compared to polymers having a similar density, e.g. +0.0025 g/cm³, made from other hafnium metallocenes. These polymers are desirable for a number of applications, including films, among others. As such, providing an improved MWCDI is advantageous. Further, the compositions disclosed herein can be utilized to make polymers desirably having an improved, e.g. greater, weight average molecular weight (M_{w}) to number average molecular weight (Mn) ratio (Mw/Mn), and/or an improved, e.g., reduced, melt index (I₂₁), as compared to polymers made from other hafnium metallocenes. Such polymers are advantageous for a number of applications.

The bicyclic hafnium metallocenes having nonidentical ligands disclosed herein, can be represented by formula (I): ABMX₂, where: A is a bicyclic structure; and B is a substituted cyclopentadienyl; M is hafnium; and X is a leaving group, wherein the bicyclic structure comprises a ((C₁-C₆)alkyl)n-substituted cyclopentadienyl ring and a non-aromatic cyclic structure fused with the ((C₁-C₆)alkyl)n-substituted cyclopentadienyl ring such that the bicyclic structure includes 7 to 9 ring carbon atoms and wherein subscript n is 1, 2, or 3. Because embodiments of the present disclosure provide that A is different than B, the hafnium metallocenes are referred to as having nonidentical ligands.

For the formula ABMX₂, where A is a bicyclic structure, A includes two cyclic structures, i.e. a cyclopentadienyl ring and non-aromatic cyclic structure fused together. One or more embodiments provide that the A bicyclic structure is a tetrahydropentalenyl. As mentioned, the cyclopentadienyl ring of A is substituted. Non-limiting examples of substituent groups include alkyls. More particular non-limiting examples of alkyl substituents include methyl, ethyl, propyl, butyl, pentyl, hexyl groups. As an example, one or more embodiments provide that the alkyl substituents include isopropyl or isobutyl. One or more embodiments provide that the cyclopentadienyl ring of A is a ((C₁-C₆)alkyl)n-substituted cyclopentadienyl ring wherein subscript n is 1, 2, or 3. One or more embodiments provide that the cyclopentadienyl ring of A is substituted with only two alkyls each having from 1 to 6 carbons; in other words, the cyclopentadienyl ring of A has no other substitutions other than the two alkyls each having from 1 to 6 carbons (in this instance, subscript n is 2). One or more embodiments provide that the cyclopentadienyl ring of A is substituted with only two alkyls each having from 1 to 3 carbons. One or more embodiments provide that the cyclopentadienyl ring of A is substituted with only two alkyls each having 1 carbon. One or more embodiments provide that the cyclopentadienyl ring of A is substituted with only one alkyl having from 1 to 6 carbons. One or more embodiments provide that the cyclopentadienyl ring of A is substituted with only one alkyl having from 1 to 3 carbons. One or more embodiments provide that the cyclopentadienyl ring of A is substituted with only one alkyl having 1 carbon. One or more embodiments provide that when the cyclopentadienyl ring of A is substituted with only two alkyls that are respectively located at the 1 and 3 positions of the cyclopentadienyl ring, e.g., as shown herein with structure (II).

Embodiments provide that another cyclic structure, i.e. the non-aromatic cyclic structure, is fused with the cyclopentadienyl ring of A, as such A is a bicyclic structure. For instance, the cyclopentadienyl ring may have two adjacent substituent groups that are joined together, and along with the carbon atoms to which they are attached, to make the bicyclic structure. As mentioned, the A bicyclic structure includes 8 to 9 ring carbon atoms. One or more embodiments provide that the A bicyclic structure includes 9 ring carbon atoms. One or more embodiments provide that the A bicyclic structure includes 8 ring carbon atoms.

Embodiments provide that the non-aromatic cyclic structure fused to the cyclopentadienyl ring of A may be and substituted or unsubstituted. Non-limiting examples of substituent groups include groups include alkyls, among others. The substituent group may be a linear alkyl or a branched alkyl. More particular non-limiting examples of alkyl substituents include methyl, ethyl, propyl, butyl, pentyl, hexyl groups and the like. One or more embodiments provide that the non-aromatic cyclic structure fused to the cyclopentadienyl ring of A is substituted with only one alkyl having from 1 to 6 carbons. One or more embodiments provide that the non-aromatic cyclic structure fused to the cyclopentadienyl ring of A is substituted with only one alkyl having from 1 to 3 carbons. One or more embodiments provide that the non-aromatic cyclic structure fused to the cyclopentadienyl ring of A is substituted with only one alkyl having 1 carbon. One or more embodiments provide that the non-aromatic cyclic structure fused to the cyclopentadienyl ring of A is unsubstituted.

For the formula ABMX₂, where B is a substituted cyclopentadienyl, non-limiting examples of substituent groups include alkyls. More particular non-limiting examples of alkyl substituents include methyl, ethyl, propyl, butyl, pentyl, hexyl groups and the like. As an example, one or more embodiments provide that the alkyl substituents include isopropyl or isobutyl. One or more embodiments provide that the cyclopentadienyl ring of B is substituted with only one alkyl having from 1 to 6 carbons. One or more embodiments provide that the cyclopentadienyl ring of B is substituted with only one alkyl having from 1 to 3 carbons. One or more embodiments provide that the cyclopentadienyl ring of B is substituted with only one alkyl having 1 carbon. One or more embodiments provide that the cyclopentadienyl ring of B is substituted with only one alkyl having 2 carbons. One or more embodiments provide that the cyclopentadienyl ring of B is substituted with only one alkyl having 3 carbons.

One or more embodiments provide that the bicyclic hafnium metallocenes having nonidentical ligands represented by formula (I): ABMX₂ may be represented by structure (1):

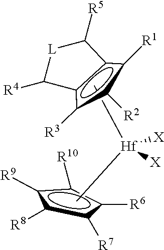

where: R¹, R², and R³ are each independently selected from hydrogen or a ((C₁-C₆)alkyl) with the proviso that at least one of R¹, R², and R³ is a ((C₁-C₆)alkyl); R⁴ and R⁵ are each independently selected from hydrogen or a ((C₁-C₆)alkyl); L is (C(R¹¹)₂)ₘ wherein R¹¹ is selected from a substituted or unsubstituted (C₁-C₂₀)hydrocarbyl group, a substituted or unsubstituted (C₁-C₂₀)heterohydrocarbyl group, a substituted or unsubstituted (C₁-C₂₀)aryl group, a substituted or unsubstituted (C₁-C₂₀)heteroaryl group, or hydrogen, and subscript m is 0, 1, or 2; R⁶, R⁷, R⁸, R⁹, and R¹⁰ are each independently selected from hydrogen or a ((C₁-C₆)alkyl).

As shown in structure (1), A is a bicyclic structure that comprises a ((C₁-C₆)alkyl)n-substituted cyclopentadienyl ring and a non-aromatic cyclic structure fused with the ((C₁-C₆)alkyl)n-substituted cyclopentadienyl ring such that the bicyclic structure includes 8 to 9 ring carbon atoms; B is a cyclopentadienyl M is hafnium; and X is a leaving group.

One or more embodiments provide that the bicyclic hafnium metallocenes having nonidentical ligands represented by formula (I): ABMX₂, may be represented by structure (II):

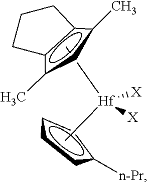

wherein X is Cl or Me.

As shown in structure (II), A is a bicyclic structure that comprises a ((C₁-C₆)alkyl)n-substituted cyclopentadienyl ring and a non-aromatic cyclic structure fused with the ((C₁-C₆)alkyl)n-substituted cyclopentadienyl ring such that the bicyclic structure includes 7 to 9 ring carbon atoms; B is a cyclopentadienyl, M is hafnium; and X is a leaving group. For structure (II), subscript n is 2, corresponding to the two C₁ alkyls respectively located at the 1 and 3 positions of the bicyclic structure. For structure (II), B is a substituted cyclopentadienyl, where B is substituted with only one alkyl having 3 carbons.

As mentioned, e.g. for formula (I): ABMX₂ and previously shown structure (II), X is a leaving group. One or more embodiments provide that X is selected from alkyls, aryls, hydridos, and halogens. One or more embodiments provide that X is methyl. Examples of X include halogen ions, hydrides, C₁ to C₁₂ alkyls, C₂ to C₁₂ alkenyls, C₆ to C₁₂ aryls, C₇ to C₂₀ alkylaryls, C₁ to C₁₂ alkoxys, C₆ to C₁₁₆ aryloxys, C₇ to C₈ alkylaryloxys, C₁ to C₁₂ fluoroalkyls, C₆ to C₁₂ fluoroaryls, and C₁ to C₁₂ heteroatom-containing hydrocarbons and substituted derivatives thereof; one or more embodiments include hydrides, halogen ions, C₁ to C₆ alkyls, C₂ to C₆ alkenyls, C₇ to C₁₈ alkylaryls, C₁ to C₆ alkoxys, C₆ to C₁₄ aryloxys, C₇ to C₁₆ alkylaryloxys, C₁ to C₆ alkylcarboxylates, C₁ to C₆ fluorinated alkylcarboxylates, C₆ to C₁₂ arylcarboxylates, C₇ to C₁₈ alkylarylcarboxylates, C₁ to C₆ fluoroalkyls, C₂ to C₆ fluoroalkenyls, and C₇ to C₁₈ fluoroalkylaryls; one embodiment includes hydride, chloride, fluoride, methyl, phenyl, phenoxy, benzoxy, tosyl, fluoromethyls and fluorophenyls; one or more embodiments include C₁ to C₁₂ alkyls, C₂ to C₁₂ alkenyls, C₆ to C₁₂ aryls, C₇ to C₂₀ alkylaryls, substituted C₁ to C₁₂ alkyls, substituted C₆ to C₁₂ aryls, substituted C₇ to C₂₀ alkylaryls, and C₁ to C₁₂ heteroatom-containing alkyls, C₁ to C₁₂ heteroatom-containing aryls, and C₁ to C₁₂ heteroatom-containing alkylaryls; one or more embodiments include chloride, fluoride, C₁ to C₆ alkyls, C₂ to C₆ alkenyls, C₇ to C₁₈ alkylaryls, halogenated C₁ to C₆ alkyls, halogenated C₂ to C₆ alkenyls, and halogenated C₇ to C₁₈ alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, C₁ to C₁₀ alkyls, C₂ to C₁₂ alkenyls, carboxylates, acetylacetonates, and alkoxides. In one or more embodiments, X is methyl.

The bicyclic hafnium metallocenes having nonidentical ligands disclosed herein can be made by processes, i.e. with conventional solvents, reaction conditions, reaction times, and isolation procedures, utilized for making known metallocenes.

As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched and cyclic paraffin radicals that are deficient by one hydrogen. Thus, for example, CH₃ (“methyl”) and CH₂CH₃ (“ethyl”) are examples of alkyls.

As used herein, an “alkenyl” includes linear, branched and cyclic olefin radicals that are deficient by one hydrogen; alkynyl radicals include linear, branched and cyclic acetylene radicals deficient by one hydrogen radical.

As used herein, “aryl” groups include phenyl, naphthyl, pyridyl and other radicals whose molecules have the ring structure characteristic of benzene, naphthylene, phenanthrene, anthracene, etc. It is understood that an “aryl” group can be a C₆ to C₂₀ aryl group. For example, a C₆H₅ aromatic structure is an “phenyl”, a C₆H₄ 2 aromatic structure is an “phenylene”. An “arylalkyl” group is an alkyl group having an aryl group pendant therefrom. It is understood that an “aralkyl” group can be a C₇ to C₂₀ aralkyl group. An “alkylaryl” is an aryl group having one or more alkyl groups pendant therefrom.

As used herein, an “alkylene” includes linear, branched and cyclic hydrocarbon radicals deficient by two hydrogens. Thus, CH₂ (“methylene”) and CH₂CH₂ (“ethylene”) are examples of alkylene groups. Other groups deficient by two hydrogen radicals include “arylene” and “alkenylene”.

As used herein, the term “heteroatom” includes any atom selected from the group consisting of B, Al, Si, Ge, N, P, O, and S. A “heteroatom-containing group” is a hydrocarbon radical that contains a heteroatom and may contain one or more of the same or different heteroatoms, and from 1 to 3 heteroatoms in a particular embodiment. Non-limiting examples of heteroatom-containing groups include radicals (monoradicals and diradicals) of imines, amines, oxides, phosphines, ethers, ketones, oxoazolines heterocyclics, oxazolines, and thioethers.

As used herein, the term “substituted” means that one or more hydrogen atoms in a parent structure has been independently replaced by a substituent atom or group. Substituent atoms may independently be selected from halogens, e.g., Cl, F, Br, and substituent groups may independently be selected from hydroxyl groups, carbonyl groups, carboxyl groups, amine groups, phosphine groups, alkoxy groups, phenyl groups, naphthyl groups, C₁ to C₂₀ alkyl groups, C₂ to C₂₀ alkenyl groups, and combinations thereof. Examples of substituted alkyls and aryls includes, but are not limited to, primary acyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals, and combinations thereof.

As mentioned, the bicyclic hafnium metallocenes having nonidentical ligands can be utilized to make catalyst compositions. As used herein “bicyclic hafnium metallocene catalyst composition” refers to a composition including the bicyclic hafnium metallocene having nonidentical ligands and an activator. As used herein, “activator” refers to any compound or combination of compounds, supported, or unsupported, which can activate a complex or a catalyst component, such as by creating a cationic species of the catalyst component. For example, this can include the abstraction of at least one leaving group, e.g., the “X” groups described herein, from the metal center of the complex/catalyst component, e.g. the metal complex of Formula I. The activator may also be referred to as a “co-catalyst”. As used herein, “leaving group” refers to one or more chemical moieties bound to a metal atom and that can be abstracted by an activator, thus producing a species active towards olefin polymerization. Various catalyst compositions, e.g., olefin polymerization catalyst compositions, are known in the art and different known catalyst composition components may be utilized. Various amounts of known catalyst composition components may be utilized for different applications.

One or more embodiments provide that the bicyclic hafnium metallocenes having nonidentical ligands can be utilized to make spray-dried catalyst compositions. As used herein, “spray-dried catalyst composition” refers to a catalyst composition that had undergone a spray-drying process. Various spray-drying process are known in the art and are suitable for forming the spray-dried catalyst compositions disclosed herein.

In one or more embodiments, the spray-drying process may comprise atomizing a composition including the bicyclic hafnium metallocene having nonidentical ligands. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry may be combined with one or more additional catalysts or other known components prior to delivery into a polymerization reactor.

In one or more embodiments, the spray-dried composition may be formed by contacting a spray dried activator particle, such as spray dried MAO, with a solution of the bicyclic hafnium metallocene having nonidentical ligands. Such a solution of bicyclic hafnium metallocene having nonidentical ligands typically is made in an inert hydrocarbon solvent and is sometimes called a trim solution. Such a spray-dried composition comprised of contacting a trim solution of the bicyclic hafnium metallocene having nonidentical ligands with a spray dried activator particle, such as spray-dried MAO, may be made in situ in a feed line heading into a gas phase polymerization reactor by contacting the trim solution with a slurry, typically in mineral oil, of the spray-dried activator particle.

Various spray-drying conditions may be utilized for different applications. For instance, the spray-drying process may utilize a drying temperature from 115 to 185° C. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

The bicyclic hafnium metallocenes having nonidentical ligands may be utilized to make a polymer. For instance, as mentioned, the bicyclic hafnium metallocenes having nonidentical ligands may be activated, i.e. with an activator, to make a bicyclic hafnium metallocene catalyst composition. The activator can include a Lewis acid or a non-coordinating ionic activator or ionizing activator, or any other compound including Lewis bases, aluminum alkyls, and/or conventional-type co-catalysts. Activators include methylaluminoxane (MAO) and modified methylaluminoxane (MMAO), among others. One or more embodiments provide that the activator is methylaluminoxane. Activating conditions are well known in the art. Known activating conditions may be utilized.

A molar ratio of metal, e.g., aluminum, in the activator to hafnium in the bicyclic hafnium metallocene having nonidentical ligands may be 1500:1 to 0.5:1, 300:1 to 1:1, or 150:1 to 1:1. One or more embodiments provide that the molar ratio of the activator to hafnium in the bicyclic hafnium metallocene having nonidentical ligands is at least 75:1. One or more embodiments provide that the molar ratio of the activator to hafnium in the bicyclic hafnium metallocene having nonidentical ligands is at least 100:1. One or more embodiments provide that the molar ratio of the activator to hafnium in the bicyclic hafnium metallocene having nonidentical ligands is at least 150:1.

The bicyclic hafnium metallocenes having nonidentical ligands, as well as a number of other components discussed herein, can be supported on the same or separate supports, or one or more of the components may be used in an unsupported form. Utilizing the support may be accomplished by any technique used in the art. One or more embodiments provide that the spray-dry process is utilized. The support may be functionalized.

A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. Additional support materials may include porous acrylic polymers, nanocomposites, aerogels, spherulites, and polymeric beads. An example of a support is fumed silica available under the trade name Cabosil™ TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The bicyclic hafnium metallocenes having nonidentical ligands, e.g., upon activation, and an olefin can be contacted under polymerization conditions to form a polymer, e.g., a polyolefin polymer. The polymerization process may be a suspension polymerization process, a slurry polymerization process, and/or a gas phase polymerization process. The polymerization may utilize a solution comprising the bicyclic hafnium metallocene having nonidentical ligands. The polymerization process may utilize using known equipment and reaction conditions, e.g., known polymerization conditions. The polymerization process is not limited to any specific type of polymerization system. The polymer can be utilized for a number of articles such as films, fibers, nonwoven and/or woven fabrics, extruded articles, and/or molded articles.

One or more embodiments provide that the polymers are made utilizing a gas-phase reactor system. One or more embodiments provide that a single gas-phase reactor, e.g., in contrast to a series of reactors, is utilized. For instance, the polymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer. A higher α-olefin refers to an α-olefin having 3 or more carbon atoms.

Polyolefins disclosed herein include polymers made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1-hexene, and 1-octene. Examples of polyolefins include ethylene-based polymers, having at least 50 wt % ethylene, including ethylene-1-butene, ethylene-1-hexene, and ethylene-1-octene copolymers, among others. One or more embodiments provide that the polymer can include from 50 to 99.9 wt % of units derived from ethylene based on a total weight of the polymer. All individual values and subranges from 50 to 99.9 wt % are included; for example, the polymer can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polymer. The polymer can include from 0.1 to 50 wt % of units derived from comonomer based on the total weight of the polymer. One or more embodiments provide that ethylene is utilized as a monomer and hexene is utilized as a comonomer.

As mentioned, the polymers made with the bicyclic hafnium metallocenes having nonidentical ligands disclosed herein can be made in a fluidized bed reactor. The fluidized bed reactor can have a reaction temperature from 10 to 130° C. All individual values and subranges from 10 to 130° C. are included; for example, the fluidized bed reactor can have a reaction temperature from a lower limit of 10, 20, 30, 40, 50, or 55° C. to an upper limit of 130, 120, 110, 100, 90, 80, 70 or 60° C.

The fluidized bed reactor can have an ethylene partial pressure from 60 to 250 pounds per square inch (psi). All individual values and subranges from 60 to 250 are included; for example, the fluidized bed reactor can have an ethylene partial pressure from a lower limit of 60, 75, 85, 90, or 95 psi to an upper limit of 250, 240, 220, 200, 150, or 125 psi.

One or more embodiments provide that ethylene is utilized as a monomer and hexene is utilized as a comonomer. The fluidized bed reactor can have a comonomer to ethylene mole ratio, e.g., C₆/C₂, from 0.0001 to 0.100. All individual values and subranges from 0.0001 to 0.100 are included; for example, the fluidized bed reactor can have a comonomer to ethylene mole ratio from a lower limit of 0.0001, 0.0005, 0.0007, 0.001, 0.0015, 0.002, 0.007, or 0.010 to an upper limit of 0.100, 0.080, or 0.050.

When hydrogen is utilized for a polymerization process, the fluidized bed reactor can have a hydrogen to ethylene mole ratio (H₂/C₂) from 0.00001 to 0.00900, for instance. All individual values and subranges from 0.00001 to 0.00900 are included; for example, the fluidized bed reactor can have a H₂/C₂ from a lower limit of 0.00001, 0.00005, or 0.00008 to an upper limit of 0.00900, 0.00700, or 0. 0.00500. One or more embodiments provide that hydrogen is not utilized.

A number of polymer properties may be determined utilizing Gel Permeation Chromatography. For instance, weight average molecular weight (Mw), number average molecular weight (Mn), Z-average molecular weight (Mz), and Mw/Mn (PDI) were determined using a High Temperature Gel Permeation Chromatography (Polymer Laboratories), equipped with a differential refractive index detector (DRI); 3 columns (Polymer Laboratories PLgel 10 μm Mixed-B) were used. The nominal flow rate was 1.0 mL/min, and the nominal injection volume was 300 μL. Transfer lines, columns, and differential refractometer (the DRI detector) were contained in an oven maintained at 160° C. Solvent was prepared by dissolving butylated hydroxytoluene (6 grams) as an antioxidant in 4 liters of Aldrich reagent grade 1, 2, 4 trichlorobenzene (TCB). The TCB mixture was then filtered through a 0.1 μm Teflon filter. The TCB was then degassed with an online degasser before entering the GPC instrument. Polymer solutions were prepared by placing dry polymer in glass vials, adding a desired amount of TCB, then heating the mixture at 160° C. with continuous shaking for approximately 2 hours. All quantities were measured gravimetrically. The injection concentration was from 0.5 to 2.0 mg/ml, with lower concentrations being used for higher molecular weight samples. Prior to running each sample the DRI detector was purged. The flow rate in the apparatus was then increased to 1.0 ml/minute, and the DRI was allowed to stabilize for 8 hours before injecting the first sample. The molecular weight was determined by combining universal calibration relationship with the column calibration which is performed with a series of monodispersed polystyrene (PS) standards. The Mw was calculated at each elution volume with following equation:

$$log {M}_{X} = \frac{log ( {K}_{X} / {K}_{P S} )}{{a}_{X} + 1} + \frac{{a}_{P S} + 1}{{a}_{X} + 1} log {M}_{P S}$$

where the variables with subscript “X” stand for the test sample while those with subscript “PS” stand for PS. For calculations,

a_{PS}=0.67

K_{PS}=0.000175

aₓ and Kₓ were obtained from published literature (a/K=0.695/0.000579 for PE and 0.705/0.0002288 for PP).
The concentration, c, at each point in the chromatogram was calculated from the baseline-subtracted DRI signal, IDRI, using the following equation:

c=KDRIIDRI/(dn/dc)

where KDRI is a constant determined by calibrating the DRI, and (dn/dc) is the refractive index increment for the system. Specifically, dn/dc=0.109 for polyethylene. The mass recovery was calculated from the ratio of the integrated area of the concentration chromatography over elution volume and the injection mass which is equal to the pre-determined concentration multiplied by injection loop volume. All molecular weights are reported in g/mol unless otherwise noted.

The comonomer content, e.g., 1-hexene, incorporated in the polymers was determined by rapid FT-IR spectroscopy on the dissolved polymer in a GPC measurement. Comonomer content was determined with respect to polymer molecular weight by use of an infrared detector (an IR5 detector) in a gel permeation chromatography measurement, as described in Analytical Chemistry 2014, 86(17), 8649-8656. “Toward Absolute Chemical Composition Distribution Measurement of Polyolefins by High-Temperature Liquid Chromatography Hyphenated with Infrared Absorbance and Light Scattering Detectors” by Dean Lee, Colin Li Pi Shan, David M. Meunier, John W. Lyons, Rongjuan Cong, and A. Willem deGroot. Analytical Chemistry 2014 86 (17), 8649-8656.

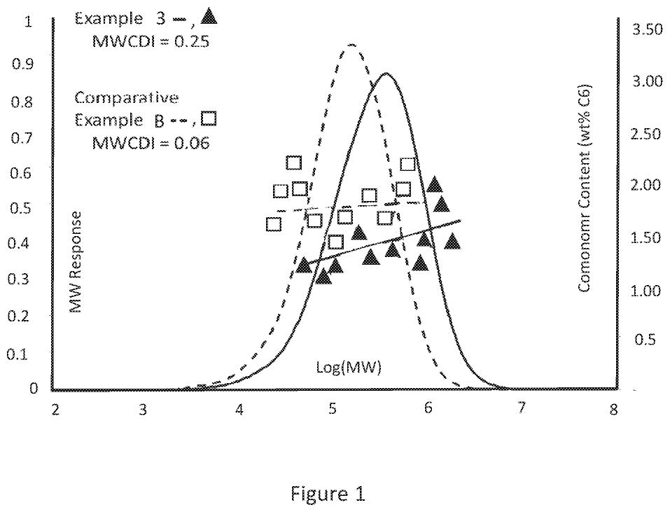

The comonomer distribution, or short chain branching distribution, in an ethylene/α-olefin copolymer can be characterized as either normal (also referred to as having a Zeigler-Natta distribution), reverse, or flat. Several reported methods are utilized to quantify a Broad Orthogonal Composition Distribution (BOCD). Herein, a simple line fit is utilized such that the normal or reverse nature of the comonomer distribution can be quantified by the molecular weight comonomer distribution index (MWCDI), which is the slope of the linear regression of the comonomer distribution taken from a compositional GPC measurement, wherein the x-axis is Log(MW) and the y-axis is weight percent of comonomer. FIG. 1 shows MWCDI for polymers made respectively with Example 3 and Comparative Example B of the Examples section of the present application. A reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the larger MWCDI value is defined to have a greater, i.e., increased, BOCD; in other words, the polymer with the larger MWCDI value has a greater reverse comonomer distribution. For instance, as reported in Table 1, polymer made with Example 3 (MWCDI=0.25) provides an increased BOCD as compared to a polymer made with Comparative Example B (MWCDI=0.06), where both Example 3 and Comparative Example B provide polymers that have a density that is +0.0025 g/cm³ of one another. Polymers with greater MWCDI, where the polymers have a similar density, can provide improved physical properties, such as improved film performance, as compared to polymers having a relatively lesser MWCDI.

The polymers made with the bicyclic hafnium metallocenes having nonidentical ligands disclosed herein can have a MWCDI from 0.08 to 2.50. All individual values and subranges from 0.08 to 2.50 are included; for example, the polymer can have a MWCDI from a lower limit of 0.08, 0.09, or 0.10 to an upper limit of 2.50, 2.35, or 2.00.

The polymers made with the bicyclic hafnium metallocenes having nonidentical ligands disclosed herein can have a density from 0.9000 to 0.9900 g/cm³. All individual values and subranges from 0.9000 to 0.9900 g/cm³ are included; for example, the polymer can have a density from a lower limit of 0.9000, 0.9100, or 0.9150 g/cm³ to an upper limit of 0.9900, 0.9700, or 0.9500 g/cm³. Density can be determined by according to ASTM D792.

The polymers made with the bicyclic hafnium metallocenes having nonidentical ligands disclosed herein can have a melt index (I₂₁) from 0.05 to 25 dg/min. I₂₁ can be determined according to ASTM D1238 (190° C., 21.6 kg). All individual values and subranges from 0.05 to 25 dg/min are included; for example, the polymer can have an I₂₁ from a lower limit of 0.05, 0.07 or 0.10 dg/min to an upper limit of 25, 15, or 5 dg/min. The polymers discussed herein can advantageously provide an improved, e.g. reduced, I₂₁ as compared to polymers having a similar density, e.g. ±0.0025 g/cm³, made from other hafnium metallocenes. This improved melt index may provide improved processability for a number of applications, for instance.

The polymers made with the bicyclic hafnium metallocenes having nonidentical ligands disclosed herein can have a weight average molecular weight (Mw) from 10,000 to 1,000,000 g/mol. All individual values and subranges from 10,000 to 1,000,000 g/mol are included; for example, the polymers can have an Mw from a lower limit of 10,000, 50,000, or 100,000 g/mol to an upper limit of 1,000,000, 800,000, or 600,000 g/mol. Mw can be determined by gel permeation chromatography (GPC), as is known in the art. GPC is discussed herein.

The polymers made with the bicyclic hafnium metallocenes having nonidentical ligands disclosed herein can have a number average molecular weight (Mn) from 5,000 to 300,000 g/mol. All individual values and subranges from 5,000 to 300,000 g/mol are included; for example, the polymers can have an Mn from a lower limit of 5,000, 20,000, or 50,000 g/mol to an upper limit of 300,000, 275,000, or 225,000 g/mol. Mn can be determined by GPC.

The polymers made with the bicyclic hafnium metallocenes having nonidentical ligands disclosed herein can have a Z-average molecular weight (Mz) from 40,000 to 2,000,000 g/mol. All individual values and subranges from 40,000 to 2,000,000 g/mol are included; for example, the polymers can have an Mz from a lower limit of 40,000, 100,000, or 250,000 g/mol to an upper limit of 2,000,000, 1,800,000, or 1,650,000 g/mol. Mz can be determined by GPC.

The polymers made with the bicyclic hafnium metallocenes having nonidentical ligands disclosed herein can have a weight average molecular weight to number average molecular weight ratio (Mw/Mn) from 2.00 to 6.00. All individual values and subranges from 2.00 to 6.00 are included; for example, the polymers can have an Mw/Mn from a lower limit of 2.00, 2.50, or 3.00 to an upper limit of 6.00, 5.50, or 4.50. The polymers discussed herein can advantageously provide an improved, e.g. greater, Mw/Mn as compared to polymers having a similar density, e.g. +0.0025 g/cm³, made from other hafnium metallocenes. Not wishing to be bound by theory, polymers that have a greater Mw/Mn have advantages in energy input required for processing, such as extrusion, blowing of films and other processes.

A number of aspects of the present disclosure are provided as follows.

Aspect 1 provides a bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)n-substituted cyclopentadienyl ring and a non-aromatic cyclic structure fused with the ((C₁-C₆)alkyl)n-substituted cyclopentadienyl ring such that the bicyclic structure includes 7 to 9 ring carbon atoms and wherein subscript n is 1, 2, or 3.

Aspect 2 provides the bicyclic hafnium metallocene having nonidentical ligands of aspect 1, represented by structure (1):

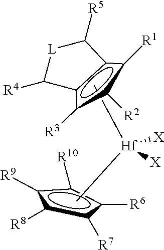

where: R¹, R², and R³ are each independently selected from hydrogen or a ((C₁-C₆)alkyl) with the proviso that at least one of R¹, R², and R³ is a ((C₁-C₆)alkyl); R⁴ and R⁵ are each independently selected from hydrogen or a ((C₁-C₆)alkyl); L is (C(R¹¹)₂)ₘ wherein R¹¹ is selected from a substituted or unsubstituted (C₁-C₂₀)hydrocarbyl group, a substituted or unsubstituted (C₁-C₂₀)heterohydrocarbyl group, a substituted or unsubstituted (C₁-C₂₀)aryl group, a substituted or unsubstituted (C₁-C₂₀)heteroaryl group, or hydrogen, and subscript m is 0, 1, or 2; R⁶, R⁷, R⁸, R⁹, and R¹⁰ are each independently selected from hydrogen or a ((C₁-C₆)alkyl).

Aspect 3 provides the bicyclic hafnium metallocene having nonidentical ligands of any one of aspects 1-2, wherein the non-aromatic cyclic structure is unsubstituted.

Aspect 4 provides the bicyclic hafnium metallocene having nonidentical ligands of any one of aspects 1-3, wherein the cyclopentadienyl ring of the bicyclic structure is substituted with two alkyls each having from 1 to 6 carbons and wherein the two alkyls are respectively located at the 1 and 3 positions of the bicyclic structure.

Aspect 5 provides the bicyclic hafnium metallocene having nonidentical ligands of any one of aspects 1-4, wherein the cyclopentadienyl of B is substituted with one alkyl having from 1 to 6 carbons.

Aspect 6 provides the bicyclic hafnium metallocene having nonidentical ligands of any one of aspects 1-5, wherein the bicyclic hafnium metallocene having nonidentical ligands is represented by structure (II):

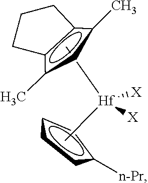

wherein X is Cl or Me.

Aspect 7 provides a bicyclic hafnium metallocene catalyst composition comprising: a bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)ₙ-substituted cyclopentadienyl ring and a non-aromatic cyclic structure fused with the ((C₁-C₆)alkyl)ₙ-substituted cyclopentadienyl ring such that the bicyclic structure includes 7 to 9 ring carbon atoms and wherein subscript n is 1, 2, or 3; and
an activator.

Aspect 8 provides the bicyclic hafnium metallocene catalyst composition of aspect 7 further comprising a support.

Aspect 9 the bicyclic hafnium metallocene catalyst composition of any one of aspects 7-8, wherein a molar ratio of metal in the activator to hafnium in the bicyclic hafnium metallocene having nonidentical ligands is 1500:1 to 0.5:1.

Aspect 10 provides the bicyclic hafnium metallocene catalyst composition of any one of aspects 7-9, wherein the composition is spray-dried.

Aspect 11 provides a method of making a polymer, the method comprising: contacting the bicyclic hafnium metallocene catalyst composition comprising: a bicyclic hafnium metallocene having nonidentical ligands represented by formula (I): ABMX2, where: A is a bicyclic structure; and B is a cyclopentadienyl; M is hafnium; and X is a leaving group, wherein the bicyclic structure comprises a ((C1-C6)alkyl)ₙ-substituted cyclopentadienyl ring and a non-aromatic cyclic structure fused with the ((C1-C6)alkyl)ₙ-substituted cyclopentadienyl ring such that the bicyclic structure includes 7 to 9 ring carbon atoms and wherein subscript n is 1, 2, or 3; and an activator, with an olefin under polymerization conditions to make the polymer.

Aspect 12 provides the method of aspect 11, wherein the polymer has a molecular weight comonomer distribution index (MWCDI) from 0.08 to 2.50.

Aspect 13 provides the aspect of any one of aspects 11-12, wherein the bicyclic hafnium metallocene catalyst composition is supported.

Aspect 14 provides the method of any one of aspects 11-13, wherein contacting the bicyclic hafnium metallocene catalyst composition and the olefin under polymerization conditions to make the polymer occurs in a polymerization reactor.

Aspect 15 provides the method of any one of aspects 11-14, wherein contacting the bicyclic hafnium metallocene catalyst composition and the olefin under polymerization conditions to make the polymer occurs in a polymerization reactor.

Aspect 16 provides the method of aspect 15, wherein the polymerization reactor is a gas-phase polymerization reactor.

### Examples

1H-NMR (proton nuclear magnetic resonance spectroscopy) chemical shift data are reported in parts per million (ppm) down field relative to tetramethylsilane (TMS), δ scale, using residual protons in deuterated solvent as references. The 1H-NMR chemical shift data measured in CDCl3 are referenced to 7.26 ppm, data measured in benzene-d6 (C6D6) to 7.16 ppm, data measured in tetrahydrofuran-d8 (THF-d8) to 3.58 ppm. 1H-NMR chemical shift data are reported in the format: chemical shift in ppm (multiplicity, coupling constant(s) in Hertz (Hz), and integration value. Multiplicities are abbreviated s (singlet), d (doublet), t (triplet), q (quartet), pent (pentet), m (multiplet), and br (broad).

(1,3-dimethyl-3,4,5,6-tetrahydropentalenyl)lithium, which may be represented by the following formula:

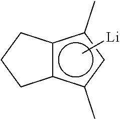

was synthesized as follows. In a glove box, in a 120 mL glass jar, 1,3-dimethyl-2,4,5,6-tetrahydropentalene (0.7 g, 5.22 mmol) was dissolved in hexanes (26 mL). A solution of n-butyl lithium in hexanes (1.6 M, 3.92 mL, 6.27 mmol) was then added dropwise while stirring; the contents were then stirred for 20 hours. The product was collected by vacuum filtration and was washed with hexanes and dried under vacuum to provide (1,3-dimethyl-3,4,5,6-tetrahydropentalenyl)lithium (0.28 g; 38% yield). H-NMR (400 MHz, THF-d8) δ 5.02 (s, 1H), 2.37 (m, 4H), 2.11 (m, 2H), 1.89 (s, 6H).

(n-Propylcylopentadienyl)hafnium trichloride, dimethoxyethane adduct, which may be represented by the following formula:

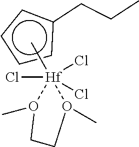

was synthesized as follows. The (n-Propylcylopentadienyl)hafnium trichloride, dimethoxyethane adduct, was synthesized by adapting the procedure described in WO2016/168448A1 by Harlan.

Bis(n-propylcyclopentadienyl)hafniumdichloride (25.1 g, 54.1 mmol) was heated to 140° C. in a 100 mL round-bottom flask until melted. HfCl₄ (17.5 g, 54.6 mmol) was added as a solid powder. The contents were heated at 140° C. for approximately 30 minutes and formed a brown viscous liquid. The 100 mL round bottom flask was attached to a short path distillation apparatus which consisted of a glass tube (90° bend) that was attached to a Schlenk flask. A vacuum was pulled on the assembly through the stopcock of the Schlenk flask. Distillation was performed from 105° C. to 110° C. with 0.4 torr vacuum. Over about an hour most of the material distilled/sublimed into the Schlenk flask or remained in the glass tube. The solid material in the u-tube was scraped out and combined with the material in the Schlenk flask. To this solid was added toluene (50 mL) and dimethoxyethane (50 mL). This was heated to reflux forming a solution, additional toluene (50 mL) was added. Upon cooling colorless needles formed. Pentane (200 mL) was added causing further formation of solid precipitate. The solid was isolated by filtration, washed with pentane (2×50 mL) and dried under vacuum to provide (n-Propylcylopentadienyl)hafnium trichloride, dimethoxyethane adduct (42.2 g); cooling the combined supernatant and washings resulted an additional 2.6 g of product that was isolated. Total yield=44.8 g (86%).

Example 1, a bicyclic hafnium metallocene having nonidentical ligands, n-PrCp(1,3-dimethyl-3,4,5,6-tetrahydropentalenyl)lithium)hafnium dichloride, which may be represented by the following formula:

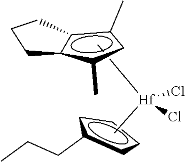

was synthesized as follows.

In drybox in a 16-oz glass jar, n-Propylcylopentadienyl)hafnium trichloride, dimethoxyethane adduct (5.50 g, 11.41 mmol) was slurried with toluene (130 mL). Then, (1,3-dimethyl-3,4,5,6-tetrahydropentalenyl)lithium (2.0 g, 14.27 mmol) was added as several small portions. Then, the contents were stirred for 24 hours at room temperature to give a reaction mixture containing synthesized n-PrCp((1,3-dimethyl-3,4,5,6-tetrahydropentalenyl)lithium)hafnium dichloride. NMR analysis, as described below, was utilized to monitor the formation of n-PrCp((1,3-dimethyl-3,4,5,6-tetrahydropentalenyl)lithium)hafnium dichloride by removing the toluene solvent from an aliquot of the reaction mixture. 1H NMR (400 MHz, Benzene-d6) δ 5.86 (t, J=2.7 Hz, 2H), 5.71 (t, J=2.7 Hz, 2H), 5.30 (s, 1H), 3.03 (ddd, J=13.7, 8.4, 1.3 Hz, 2H), 2.77-2.67 (m, 2H), 2.44 (ddd, J=14.3, 10.2, 8.0 Hz, 2H), 2.36-2.21 (m, 1H), 2.03-1.95 (m, 1H), 1.76 (s, 6H), 1.57-1.44 (m, 2H), 0.84 (td, J=7.4, 5.5 Hz, 3H).

Example 2, a bicyclic hafnium metallocene having nonidentical ligands, n-PrCp(1,3-dimethyl-3,4,5,6-tetrahydropentaleny)hafnium dimethyl was made as follows.

Methyl magnesium bromide (3.0 M, 7.61 mL, 22.83 mmol) was dropwise added to the container including the n-PrCp(1,3-dimethyl-3,4,5,6-tetrahydropentalenyl)hafnium dichloride, as discussed above, while stirring. Then, the contents were stirred for 24 hours at room temperature. Then, solvent was removed under vacuum. The resulting solid product was dissolved in hexanes (250 mL) and filtered. Hexanes were removed under vacuum to provide Example 2 (4.79 g, 93% yield). 1H NMR (400 MHz, Benzene-d6) δ 5.69 (t, J=2.7 Hz, 2H), 5.44 (t, J=2.6 Hz, 2H), 5.07 (s, 1H), 2.55-2.43 (m, 6H), 2.05-1.96 (m, 1H), 1.89-1.80 (m, 1H), 1.78 (s, 6H), 1.59 (dq, J=14.7, 7.4 Hz, 2H), 0.97-0.84 (m, 3H), −0.39 (s, 6H).

Example 2, n-PrCp(1,3-dimethyl-3,4,5,6-tetrahydropentalenyl)hafnium dimethyl, may be represented by the following formula:

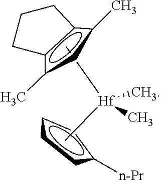

Comparative Example A, a hafnium metallocene having identical ligands, was made as follows. Bis-(n-propylcyclopentadienyl) hafnium dichloride was commercially obtained from TCI; this is readily converted to bis-(n-propylcyclopentadienyl) hafnium dimethyl by someone skilled in the art by reaction with a methylating agent, such as a Grignard reagent, for example, methylmagnesium bromide.

Comparative Example A may be represented by the following formula:

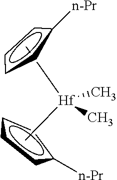

Polymer was made utilizing Example 3, a bicyclic hafnium metallocene catalyst composition. as follows. A spray-dried methylaluminoxane (MAO) was prepared as follows (as described in U.S. Pat. No. 8,497,330; See column 22, lines 48-97; with any changes indicated). Sieved toluene (754 lbs), 10% solution of MAO in toluene (491 lbs), and Cabosil TS620 (69 lbs) were added to a 270 gallon feed tank and mixed for 1 hour at 40° C. The contents of the feed tank were then introduced to an atomizing device to produce droplets that were contacted with a gas stream to evaporate the liquid, thereby forming the spray-dried methylaluminoxane, that was observed to be a powder. The spray-dried methylaluminoxane (14 wt %) was combined with hexane (10 wt %) and Hydrobite 380 mineral oil (76 wt %) to make a spray-dried slurry. Example 2 (0.04 wt %), hexane (4.00 wt %), and isopentane (95.96 wt %) were combined to make a metallocene solution. Ethylene, 1-hexene, and hydrogen were fed to a fluidized bed gas phase reactor comprising a bed of polyethylene granules. The spray-dried slurry (20 ml/hr) was fed to the reactor through a catalyst injection line ( 3/16 inch) utilizing a syringe pump. Isopentane (1.4 kg/hr) was added by the catalyst injection line after the pump. The metallocene solution (141 g/hr) was added by catalyst injection line after the isopentane and through a helical static mixer ( 3/16 inch). After the mixer, nitrogen (2.3 kg/hr) was added to the catalyst injection line. The catalyst injection line was reduced to ⅛ inch and entered the reactor through an outer tube (¼ inch). Additional nitrogen (4.1 kg/hr) and isopentane (5.0 kg/hr) were added through the outer tube. Polymerization was continuously conducted, after equilibrium was reached, under the conditions, as shown in Table 1. Polymerization was initiated by continuously feeding the spray-dried slurry and metallocene solution into a fluidized bed of polyethylene granules, together with the ethylene, 1-hexene and hydrogen. Continuity additive CA-300 (may be obtained from Univation Technologies, LLC, Houston, Texas, USA) was also fed to the reactor as a 20 weight % solution in mineral oil at a feed rate of 2.0 milliliters per hour (ml/hour). Inert gases, nitrogen and isopentane, made up the remaining pressure in the reactor. The product was continuously removed to maintain a constant bed weight of polymer in the reactor. The resulting mixture was washed with water and methanol, and dried. Polymerization conditions are utilized to provide polymers having a density of approximately 0.9300 g/cm³. Polymerization conditions are reported in Table 1.

Polymer was made utilizing Comparative Example B, a catalyst composition, as follows. Comparative B was prepared as described in U.S. Pat. No. 8,497,330; See column 22, lines 48-97; with the change that Comparative Example A, as described above, was utilized. Comparative Example B (16 wt %) was combined with Hydrobite 380 mineral oil to make a spray-dried slurry. Ethylene, 1-hexene, and hydrogen were fed to a fluidized bed gas phase reactor comprising a bed of polyethylene granules. The spray-dried slurry (20 ml/hr) was fed to the reactor through a catalyst injection line ( 3/16 inch) utilizing a syringe pump. Isopentane (1.4 kg/hr) was added by the catalyst injection line after the pump and through a helical static mixer ( 3/16 inch). After the mixer, nitrogen (2.3 kg/hr) was added to the catalyst injection line. The catalyst injection line was reduced to ⅛ inch and entered the reactor through an outer tube (¼ inch). Additional nitrogen (4.1 kg/hr) and isopentane (5.0 kg/hr) were added through the outer tube. Polymerization was continuously conducted, after equilibrium was reached, under the conditions, as shown in Table 1. Polymerization was initiated by continuously feeding the spray-dried slurry into a fluidized bed of polyethylene granules, together with the ethylene, 1-hexene and hydrogen. Continuity additive CA-300 (may be obtained from Univation Technologies, LLC, Houston, Texas, USA) was also fed to the reactor as a 20 weight % solution in mineral oil at a feed rate of 2.0 milliliters per hour (ml/hour). Inert gases, nitrogen and isopentane, made up the remaining pressure in the reactor. The product was continuously removed to maintain a constant bed weight of polymer in the reactor. The resulting mixture was washed with water and methanol, and dried. Polymerization conditions are utilized to provide polymers having a density of approximately 0.9300 g/cm³. Polymerization conditions are reported in Table 1.

A number of properties were determined for polymers made with Example 3 and Comparative Example B, the results are reported in Table 1. Catalyst productivity (grams polymer/gram catalyst-hour) was determined as a ratio of polymer produced to an amount of catalyst added to the reactor. Density was determined according to ASTM D792; melt index (I₂₁) was determined according to ASTM D1238 (190° C., 21.6 kg); Mw, Mn, Mz, and Mw/Mn were determined by GPC; molecular weight comonomer distribution index (MWCDI) was determined as discussed herein.

TABLE 1

| | | Comparative |
|---|---|---|
| | Example 3 | Example B |
| Reaction Temp (° C.) | 85 | 90 |
| C₆/C₂ | 0.0030 | 0.0028 |
| H₂/C₂ | 0.00003 | 0.00016 |
| C₂ Partial Pressure (psi) | 100 | 100 |
| Pressure (kPa) | 2405 | 2399 |
| Isopentane (mol %) | 5.8 | 6.5 |
| Density (g/cm³) | 0.9281 | 0.9306 |
| Production Rate (kg/hr) | 7.4 | 15.3 |
| Mn | 127,252 | 73,499 |
| Bed Weight (kg) | 45.9 | 44.5 |
| Mw | 456,897 | 217,821 |
| Mz | 1,168,897 | 495,113 |
| Mw/Mn | 3.59 | 2.96 |
| Melt Index (I₂₁) | 0.27 | 3.08 |
| Molecular weight comonomer | 0.25 | 0.06 |
| distribution index | | |

The data of Table 1 illustrate that polymer made with Example 3 had an improved, i.e. greater, molecular weight comonomer distribution index as compared to polymer made with Comparative Example B.

The data of Table 1 illustrate that polymer made with Example 3 had an improved, i.e. greater, Mw/Mn as compared to polymer made with Comparative Example B.

The data of Table 1 illustrate that polymer made with Example 3 had an improved, i.e. reduced, melt index (I₂₁) as compared to polymer made with Comparative Example B.

1. A bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)ₙ-substituted cyclopentadienyl ring and a non-aromatic cyclic structure fused with the ((C₁-C₆)alkyl)ₙ-substituted cyclopentadienyl ring such that the bicyclic structure includes 7 to 9 ring carbon atoms and wherein subscript n is 1, 2, or 3.

2. The bicyclic hafnium metallocene having nonidentical ligands of claim 1, represented by structure (I): 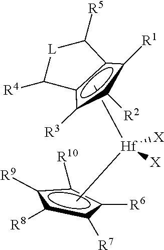
where: R¹, R², and R³ are each independently selected from hydrogen or a ((C₁-C₆)alkyl) with the proviso that at least one of R¹, R², and R³ is a ((C₁-C₆)alkyl); R⁴ and R⁵ are each independently selected from hydrogen or a ((C₁-C₆)alkyl); L is (C(R¹¹)₂)ₘ wherein R¹¹ is selected from a substituted or unsubstituted (C₁-C₂₀)hydrocarbyl group, a substituted or unsubstituted (C₁-C₂₀)heterohydrocarbyl group, a substituted or unsubstituted (C₁-C₂₀)aryl group, a substituted or unsubstituted (C₁-C₂₀)heteroaryl group, or hydrogen, and subscript m is 0, 1, or 2; R⁶, R⁷, R⁸, R⁹, and R¹⁰ are each independently selected from hydrogen or a ((C₁-C₆)alkyl).

3. The bicyclic hafnium metallocene having nonidentical ligands of claim 1, wherein the non-aromatic cyclic structure is unsubstituted.

4. The bicyclic hafnium metallocene having nonidentical ligands of claim 1, wherein the cyclopentadienyl ring of the bicyclic structure is substituted with two alkyls each having from 1 to 6 carbons and wherein the two alklys are respectively located at the 1 and 3 positions of the bicyclic structure.

5. The bicyclic hafnium metallocene having nonidentical ligands of claim 1, wherein the cyclopentadienyl of B is substituted with one alkyl having from 1 to 6 carbons.

6. The bicyclic hafnium metallocene having nonidentical ligands of claim 1, wherein the bicyclic hafnium metallocene having nonidentical ligands is represented by structure (II): 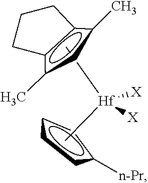
wherein X is Cl or Me.

7. A bicyclic hafnium metallocene catalyst composition comprising:
a bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)ₙ-substituted cyclopentadienyl ring and a non-aromatic cyclic structure fused with the ((C₁-C₆)alkyl)ₙ-substituted cyclopentadienyl ring such that the bicyclic structure includes 7 to 9 ring carbon atoms and wherein subscript n is 1, 2, or 3; and
an activator.

8. The bicyclic hafnium metallocene catalyst composition of claim 7 further comprising a support.

9. The bicyclic hafnium metallocene catalyst composition of claim 7, wherein a molar ratio of metal in the activator to hafnium in the bicyclic hafnium metallocene having nonidentical ligands is be 1500:1 to 0.5:1.

10. The bicyclic hafnium metallocene catalyst composition of claim 7, wherein the composition is spray-dried.

11. A method of making a polymer, the method comprising:
contacting the bicyclic hafnium metallocene catalyst composition comprising:
a bicyclic hafnium metallocene having nonidentical ligands represented by formula (I): ABMX₂, where: A is a bicyclic structure; and B is a cyclopentadienyl; M is hafnium; and X is a leaving group, wherein the bicyclic structure comprises a ((C₁-C₆)alkyl)ₙ-substituted cyclopentadienyl ring and a non-aromatic cyclic structure fused with the ((C₁-C₆)alkyl)ₙ-substituted cyclopentadienyl ring such that the bicyclic structure includes 7 to 9 ring carbon atoms and wherein subscript n is 1, 2, or 3; and
an activator,
with an olefin under polymerization conditions to make the polymer.

12. The method of claim 11, wherein the polymer has a molecular weight comonomer distribution index (MWCDI) from 0.08 to 2.50.

13. The method of claim 11, wherein the bicyclic hafnium metallocene catalyst composition is supported.

14. The method of claim 11, wherein the bicyclic hafnium metallocene catalyst composition is spray-dried.

15. The method of claim 11, wherein contacting the bicyclic hafnium metallocene catalyst composition and the olefin under polymerization conditions to make the polymer occurs in a polymerization reactor.

16. The method of claim 15, wherein the polymerization reactor is a gas-phase polymerization reactor.
